(19) United States
(12) Patent Application Publication
(10) Pub. No.: US 2015/0023723 A1
(43) Pub. Date: Jan. 22, 2015

(54) SYSTEMS AND METHODS FOR MANAGING AND ORGANIZING DOCUMENTS

(71) Applicant: Minder, LLC, Portland, OR (US)

(72) Inventor: Trisha J. Thompson, Portland, OR (US)

(21) Appl. No.: 14/335,768

(22) Filed: Jul. 18, 2014

Related U.S. Application Data
(60) Provisional application No. 61/856,196, filed on Jul. 19, 2013.

(51) Int. Cl. B42F 1/00; B42F 21/02; G06Q 90/00

(52) U.S. Cl. CPC B42F 1/00; G06Q 90/00; B42F 21/02
USPC 402/73; 283/37; 412/7

(57) ABSTRACT

A document management system and method for efficiently managing documents across multiple subject areas of personal record-keeping, and for allowing a user to quickly identify and process documents that may require future action. An example system includes a first container or organizer having one or more dividers therein, the dividers retaining documents in separate categories, and further includes document retention guidelines aimed at identifying documents that may be removed from the organizers and discarded. The document retention guidelines may specify particular retention actions for managing the documents, and time periods for retaining particular documents in the organizers.

### RELATED APPLICATION DATA

This application is a nonprovisional of and claims the benefit under 35 U.S.C. §119(e) from U.S. Provisional Application No. 61/856,196, filed Jul. 19, 2013, the disclosure of which is incorporated herein by reference.

### BACKGROUND

The field of the disclosure relates generally to systems and methods for managing and/or organizing documents, and in particular, to systems and methods integrating various document management tools to efficiently and effectively organize household documents, such as financial, legal, and medical records.

In many households, people often struggle with organizing and managing the many incoming documents that they may receive on a daily basis. For example, on a given day, a household may receive various pieces of mail and other papers such as cards, flyers, coupons, advertisements, bank statements, bills, receipts, and other documents. Some of these documents may be reviewed quickly and discarded or recycled, thereby reducing the amount of documents that are held in the household. However, many of these documents, such as bills, credit card statements, and medical records, typically require the user to perform a future action by a specified deadline.

In many households, these papers are retained for reference purposes or to serve as reminders for timely completing the future action. Maintaining and managing these documents in an orderly manner is not a trivial task, especially since a household may have multiple people each receiving documents that require attention on a daily basis. In addition, many of these documents cannot be or simply are not handled on a daily basis, thereby creating a backlog of outstanding actions. To further complicate matters, some actions may require reference to historical or other documents to ensure that the action is properly completed or is consistent with past actions. Even with a typical organization system, a user may forget where the documents are stored or may be unable to quickly search and access a specific document.

In many household document organization systems, users simply group categories of documents together in a binder, folder, box, or other container. For example, an organized person may have an individual folders for his or her tax documents, medical records, bills, and credit card statements. Within each individual folder, the documents may be organized chronologically, such that each new document is put at the front of or on top of the older documents. In other households, users may lack an organization scheme altogether and simply stack all documents on a desk or place them in a box in a seemingly random order.

The present inventor has identified certain disadvantages and limitations of such organization systems and methods. One limitation for such systems is that as time goes by, more and more documents are added to the stack or the folders, and it becomes an increasingly difficult task not only to manage the documents but also to quickly find specific documents. For example, if a user is searching for a particular medical record, the user would typically search the entire medical record container to find the specific document. This approach is time consuming and limits the effectiveness of the organization system. Eventually, users are entirely overwhelmed by the difficulty of managing the numerous documents and simply give up. Another limitation of such systems is that a scheme that relies on a chronological organization may lead to the user's failure to timely perform outstanding actions. For example, a user may forget to pay a credit card statement because the statement was filed in the financial folder when it arrived, but has since been buried by later-arriving financial documents that were stored in the same folder on top of the credit card statement.

Accordingly, the present inventor has identified a need for a classification system and associated method for handling documents across various subject areas of personal record-keeping so that users are able to effectively organize and handle documents, and also quickly access any necessary documents when needed. The present inventor has also identified a need for a classification system that reduces redundancy and promotes seamless integration of documents that may be related to multiple subject areas. Additional aspects and advantages will be apparent from the following detailed description of preferred embodiments, which proceeds with reference to the accompanying drawings.

### BRIEF DESCRIPTION OF THE DRAWINGS

FIG. 1 illustrates a diagram of a document management system according to one embodiment.

FIGS. 2-3 collectively illustrate a schematic diagram of the document management system of FIG. 1.

FIG. 4 illustrates an example embodiment of a document retention key of the document management system of FIGS. 1-3.

FIG. 5 illustrates an example embodiment of a document retention legend of the document management system of FIGS. 1-3.

FIG. 6 illustrates an example embodiment for managing a document using the document management system of FIGS. 1-3.

FIG. 7 is a flowchart of a method of managing documents using the document management system of FIGS. 1-3 according to one embodiment.

### DETAILED DESCRIPTION OF EXAMPLE EMBODIMENTS

With reference to the drawings, this section describes particular embodiments of an organizational system and its detailed operation. Throughout the specification, reference to “one embodiment,” “an embodiment,” or “some embodiments” means that a particular described feature, structure, or characteristic may be included in at least one embodiment of an organizational system. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

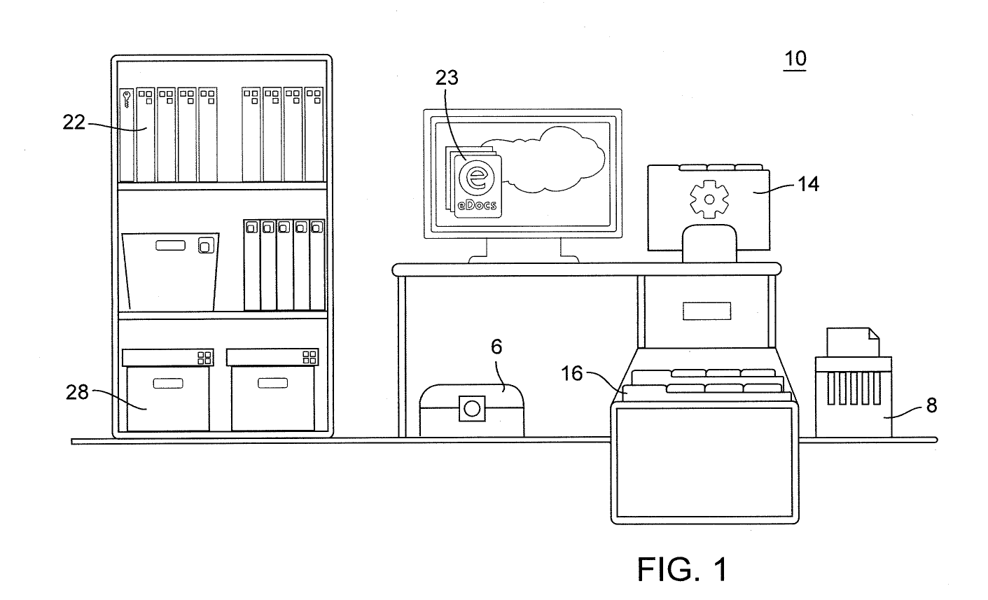

FIGS. 1-7 collectively illustrate various embodiments and features of a comprehensive document management system 10 designed to efficiently manage and store (e.g. segregate) documents 12 across multiple subject areas of personal record-keeping. The document management system 10 also provides tools to allow users to easily track and process documents 12 that may require future action, such as payment of bills and management of service providers. In addition, the document management system 10 provides users with guidance and instructions for effectively using the document management system 10 to maintain documents 12 for only as long as they are needed.

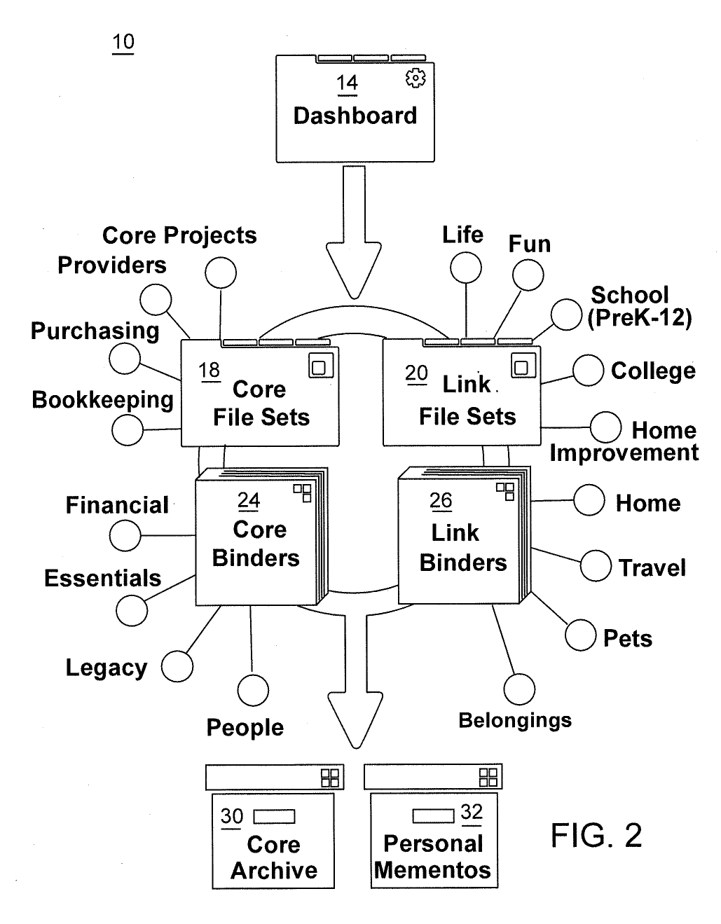

With particular reference to FIGS. 1-2, the following section briefly describes an example operation of the document management system 10. Incoming documents 12, such as mail, bills, coupons, flyers, statements, receipts, family newsletters, or other documents are received by the user and temporarily stored in a dashboard file 14 until the user is ready to further organize the documents 12 into one of the various organizers or containers (e.g., files 16, binders 22, or archive boxes 28) of the document management system 10. Once the user is ready, the user reviews the information contained in each of the documents 12 and selects an appropriate organizer or container for storing the document 12.

As briefly mentioned previously, some of these documents 12 may include or define an action task that needs to be accomplished by the user. For example, an invoice may require payment by the user of a specified amount by a particular date, or a medical document may notify the user of the time and date for the next appointment. As described in further detail below, these documents 12 may be tagged to indicate that an action is required by the user, and/or the documents 12 may be stored in a section or divider of the files 16 specifically for documents 12 that require further action by the user. Tagging or separating these documents 12 allows the user to quickly identify and address any documents 12 with outstanding actions.

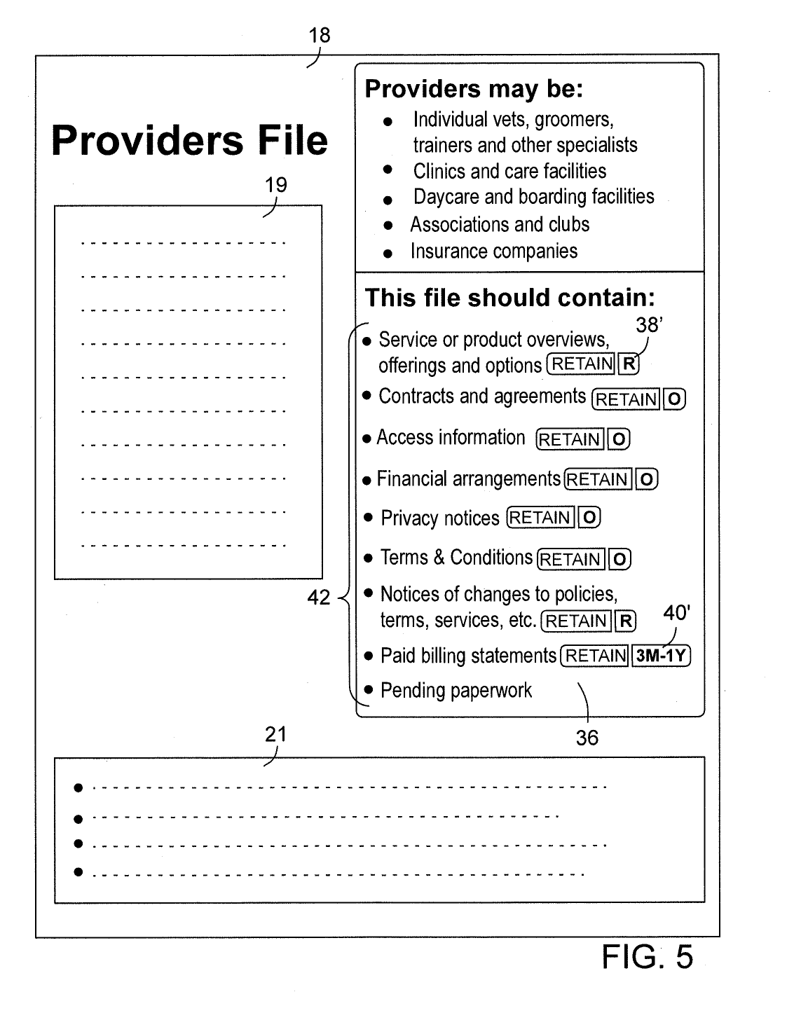

In some embodiments, once the action has been completed, the document 12 may be reclassified to a different section of the file 16, or may be moved to a different container, such as binders 22, archive boxes 28, stored in safe 6, or destroyed by document shredder 8. To manage the documents 12 and help the user purge documents 12 that may no longer be necessary to retain, the system 10 includes a document retention legend 36 with retention guidelines for managing each of the documents 12 (see FIG. 5). The following description proceeds with additional details of these and other embodiments, including details relating to the interaction and operability of the various containers of the document management system 10.

FIGS. 1-3 collectively illustrate an example embodiment of a document management system 10. With reference to FIGS. 1-3, the document management system 10 includes a dashboard 14 that drives the initial management and organization process by capturing and storing the incoming documents 12 in a convenient location until the user is ready for the review and organization process. Generally speaking, the dashboard 14 is an inbox of the document management system 10. Once the user is ready to review the documents 12 in the dashboard 14, the user reviews the information contained in each of the documents 12 to identify a classification topic for organizing the document 12 in the corresponding container (e.g., files 16, binders 22, or archive boxes 28). In some embodiments, the user may also identify whether the document 12 includes an action task specifying a subsequent action to be performed at a later date. Once the classification topic and action task have been identified, the user then selects the appropriate container and stores the document 12.

In some embodiments, the dashboard 14 may include one or more dividers 15, such as tabbed sections or other dividing structures, to create individual sections, compartments or subcategories into which the documents 12 may be stored. The dividers 15 may help prioritize and track the incoming documents 12 to simplify subsequent organization into the files 16, binders 22, or archive boxes 28, and may help identify documents 12 that require immediate attention from the user before the documents 12 are stored in other containers.

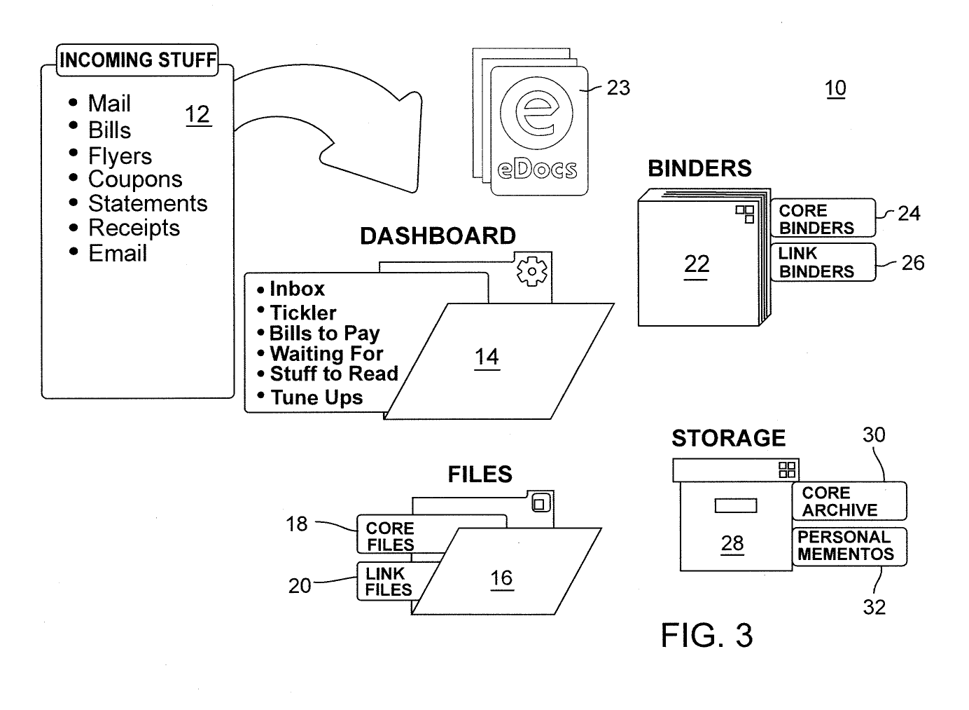

With particular reference to FIG. 3, the following section describes an example embodiment of the dashboard 14. In some embodiments, the dashboard 14 may be divided to include the following classification categories: (1) a general inbox section; (2) a section for bills to pay; (3) a section for documents that the user may be waiting for (e.g., response to an outstanding application, rebate fulfillment); (4) a section for documents to read; (5) a section for managing longer term projects (e.g., annual work plan divided monthly, plans for purchasing a home); and (6) a tickler file to track time-sensitive documents or documents with future actions. As mentioned previously, the dashboard 14 is a convenient source for temporarily storing documents 12 before sorting them into the respective containers of the document management system 10. Accordingly, the dashboard 14 may be customized as desired to reflect the needs of the individual users. In some embodiments, the dashboard 14 may be customized as illustrated in FIG. 3. In other embodiments, however, the dashboard 14 may include fewer categories, different categories, or no categories at all. In still other embodiments, the document management system 10 may not include a dashboard 14 and the user may instead store documents 12 directly into the various containers upon receipt.

The following section proceeds with a description of the interoperability of the various containers/organizers and document management methodologies of the document management system 10. In the following written description, the terms “file”, “file folders”, “binders”, and “storage boxes” may be used to refer to different organizers or containers of the organization system illustrated in the figures. It should be understood that these terms are used for convenience purposes only to simplify the description and to distinguish between the different categories of organizers that may be used for the organization systems and methods described herein. Accordingly, while a particular organizer or container may be referred to as a file (such as the dashboard file 14 described previously), this term should not be limited as requiring a typical file folder, such as a manila folder or other similar structure. Instead, the term should be viewed expansively (unless otherwise specifically limited) as including other containers or organizers suitable for retaining and or separating/segregating documents, such as a document tray, a box, a pouch, a binder, or other receptacles.

With reference to FIGS. 1-3, the document management system 10 includes files 16 for managing and segregating the documents 12. Generally, the files 16 store working materials and documents 12 that require further action from user. Essentially, the files 16 function as the mini work spaces of the document management system 10.

Preferably, the files 16 are compartmentalized into a number of smaller files, such as core files 18 and link files 20, for separating the documents 12 based on specific topics or categories, and based on a determined level of importance to the user. In one embodiment, the core files 18 include important and/or sensitive documents 12 that may be universal or common to various users, and the link files 20 include documents 12 that may be linked to or supplement the documents 12 in the core files 18. For example, in one embodiment, the core files 18 may include: (1) healthcare and medical information (such as appointments, bills, test results, and medications); (2) financial information (such as bank and credit card statements, credit reports, and credit history); (3) personal information (such as social security information and birth certificate); (4) and legal documents (such as wills, estate planning, and power of attorney documents). The link files 20 may include documents relating to life and fun activities, school, college, home improvement, gardening, travel, pets, tools, toys, and personal goods.

In some embodiments, such as for households with multiple users, some or all of the core files 18 and the link files 20 may be shared or instead individualized depending on the particular needs of the household and each user in the household. In some instances, the life stage of the particular users (e.g., a baby, a teenager, a parent) may dictate the kinds of core files 18 and link files 20 that the particular user may require and/or whether the user may need individualized files for certain subjects. For example, a baby may only require a single general core file 18 for storing all core documents 12 relating to the baby, such as personal information (e.g., a birth certificate and social security card) and medical information (such as appointments and medications), but the baby likely will not have any legal documents or financial documents associated with him or her. As the baby grows up into a teenager, the single general core file 18 may still be sufficient for the few core records that the teenager may have, but the link files 20 may increase to include school work, activities, and other personal activities that the teenager is now participating in. Alternatively, the baby/teenager may not have any individual core files 18 and may instead share a single core file 18 with the parents, so that any core household documents 12 for the parents and the baby/teenager are stored in the shared core file 18.

It should be understood that in other examples, any other container or organizer (such as the binders 22 or the archive boxes 28) of the document management system 10 may be shared or instead individualized as described in the preceding section with reference to the core and link files 18, 20. In still other embodiments, some or all of the users in the household may have individual binders (i.e., “people binders”) that may contain personal information for each individual (such as a birth certificate and a social security card). In such embodiments, as the users in the household move through the life stages (e.g., a teenage user moves out of the house to go to college), the user may take their associated people binder with them.

Similar to the dashboard file 14, the core files 18 and link files 20 may each include one or more dividers (such as tabs, section dividers, or other similar compartments), or may be comprised of a plurality of individual files (each of the individual files functioning as a divider). The dividers separate the core files 18 and the link files 20 into various subcategory topics to organize the documents 12 into focused, more manageable batches. Preferably, the subcategory topics associated with each of the dividers are displayed in printed text or other readable form on a surface (e.g., an outward facing top surface) of the each of the dividers to label the dividers so that the user can quickly find any specific divider. In addition, the dividers for both the core files 18 and link files 20 preferably include information, such as instructions, tips, and guidance prompts, and other tools, to help guide the user in determining which documents to store in particular dividers. Preferably, the information is displayed in printed text or other readable form on an interior surface of the dividers (e.g., an interior flap of a file folder) so that the user can quickly identify the information.

For example, with reference to FIG. 2, the core files 18 may include a separate divider for each of the following categories: (1) Providers; (2) Purchasing; (3) Bookkeeping, and (4) Projects relating to core subjects. In the Providers divider, a user may store documents 12 relating to various service providers (such as banks, cable and Internet companies, doctors, cell phone provider, and any other suitable service providers) used by the user. For example, the Providers divider may include bank and credit card statements, mortgage and other loan statements, cable bills and invoices, phone bills and usage statements, or other documents 12 that may be received from service providers.

Similarly, the other dividers in the core files 18 include documents 12 related to the corresponding categories. For example, the Purchasing divider may include documents 12 relating to purchases, such as coupons, food menus, loyalty rewards programs, gift cards or certificates, or similar documents. The Bookkeeping divider may include documents 12 relating generally to finances, such as budget documents, paid bills or invoices, receipts, donations, or similar documents. Finally, the Projects divider may include documents 12 relating to larger projects that the user may need to complete. For example, documents 12 in the Projects divider may relate to tax preparation, auto accidents, identity theft, job loss, and other similar long or short-term projects.

The link files 20 may be organized in a similar fashion as the core files 18, but with different categories based on particular needs of the user. For example, the link files 20 may include separate dividers for each of the following categories: (1) Life; (2) Fun; (3) Home Improvement; and (4) School. In the Life divider, a user may store documents 12 generally relating to life and community events, such as wedding planning documents, community activities, and personal correspondence with friends. In the Fun divider, a user may store documents 12 relating to activities, classes, and vacation plans. In the Home Improvement divider, a user may store documents 12 relating to home improvement projects, design ideas, and appliances. In the School divider, a user may store documents 12 relating to coursework, calendars, fundraisers associated with school, books, sports, and other school associated events.

It should be understood that the categories and example organization of documents described with regard to the core files 18 and the link files 20 simply illustrates an example embodiment and organization structure and is not meant as limiting. In other embodiments, a user may not have all of these dividers in their individual core and link files 18, 20 or may have more dividers. As described previously, the arrangement of the files 16, such as whether some or all of the files may be individualized or shared, will depend on the particular needs of the user and the household.

In some embodiments, each of the dividers in the core files 18 and the link files 20 is further compartmentalized (such as by tabs or other visual dividers) to separate the documents 12 into smaller batches. For example, the Providers divider in the core files 18 may include labeled subsections for each specific bank associated the user, their particular cable provider, and student loan provider so that the user can quickly pinpoint a particular document 12 as needed. Similarly, the Home Improvement file may be further divided to indoor projects and outdoor projects, or divided by projects for specific rooms of the house (e.g., bedroom, bathroom, living room, and kitchen).

Many of the documents 12 stored in the core files 18 and link files 20 may require further actions that need to be taken by the user. For example, the Providers file may include documents that require payment of a credit card statement or cancellation of cable service. Preferably, documents 12 that require further action from the user are marked or tagged to indicate that an action item is outstanding. In addition, or alternatively, the documents 12 may be stored in a separate divider of the Providers file, where the divider is specifically associated with action items. In such embodiments, the user would be able to quickly identify and respond to the documents 12 that require further action to help ensure that the user timely and systematically performs all necessary outstanding actions.

As mentioned previously, the core files 18 and link files 20 provide users with the ability to store and retain documents 12 in a functional manner by topic as opposed to a purely chronological or alphabetical order. Each of the core and link files 18, 20 separate documents 12 based on a specific categorical structure so that a user knows and can quickly identify the types of materials that he or she expects to find in each specific container. In addition, by separating the documents 12 into core files 18 and link files 20, the document management system 10 allows users to prioritize the more pertinent and important documents (e.g., the core files 18) to ensure that the user completes those tasks in a timely fashion.

As described above, the core and link files 18, 20 primarily contain the working documents 12 of the document management system 10 (i.e., the documents 12 that require further action from the user). With reference to FIGS. 1-2, the organization system 10 also includes one or more binders 22 for retaining documents 12 relating to resources, records, and/or other reference materials. In some embodiments, the reference materials in the binders 22 may be used to complete tasks associated with the documents 12 in the core and link files 18, 20. The following section describes additional details relating to the binders 22 of the document management system 10.

Preferably, the document management system 10 includes a core binder 24 for storing reference materials relating to the core files 18, and a link binder 26 for storing reference materials relating to the link files 20. Similar to the core and link files 18, 20, the binders 24, 26 may each include one or more dividers (such as tabs, section dividers, or other similar compartments), or may be comprised of a plurality of individual binders (each of the individual binders functioning as a divider). The dividers separate the core binder 22 and the link binder 24 into various subcategory topics to separate the documents 12 into focused, more manageable batches. Preferably, the subcategory topics associated with each of the dividers are displayed in printed text or other readable form on a surface (e.g., an outward facing top surface) of each of the dividers to label the dividers so that the user can quickly find any specific divider of the core and link binders 22, 24. In addition, the dividers for both the core binder 22 and link files 24 (similar to the dividers of the core and link files 18, 20) preferably include additional information, such as guidance prompts and instructions 19, and tips or other tools 21, to help guide the user in determining which documents to store in particular dividers (see FIG. 5). Preferably, the information 19, 21 is displayed in printed text or other readable form on an interior surface of the dividers (e.g., an interior flap of a binder 22 or core file 18) so that the user can quickly identify the information.

Preferably, the categories in the core and link binders 22, 24 are substantially similar or identical to the categories used in the core and link files 18, 20 to allow the user to quickly identify particular reference materials in the binders 24, 26 while working on the documents 12 stored in the corresponding core and link files 18, 20. In one embodiment, the binders 24, 26 may include retainers (such as central rings commonly found in three-ringed binders or prong fasteners) that may be opened or otherwise operated to receive and secure documents 12 (e.g., hole-punched documents).

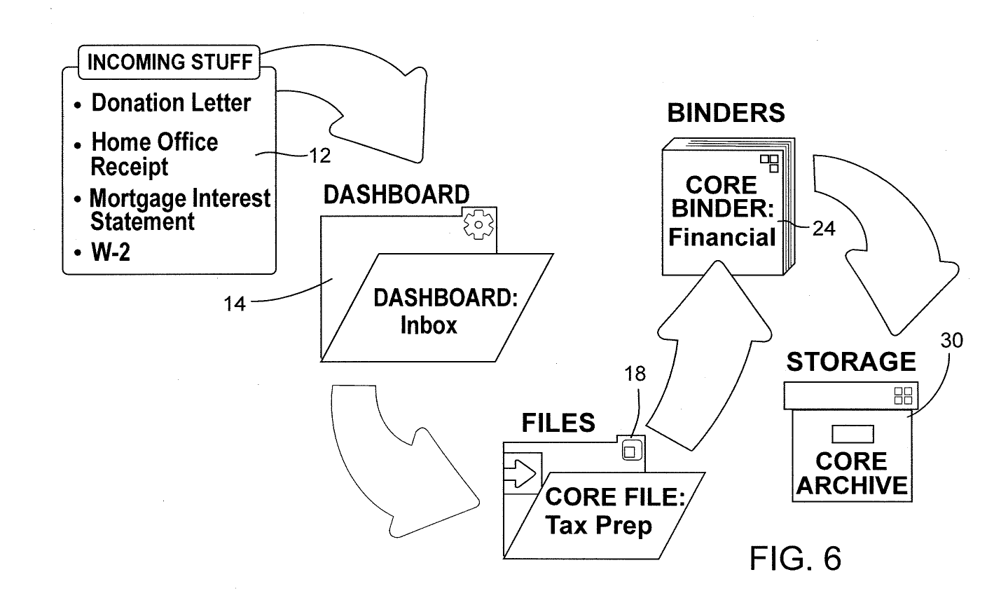

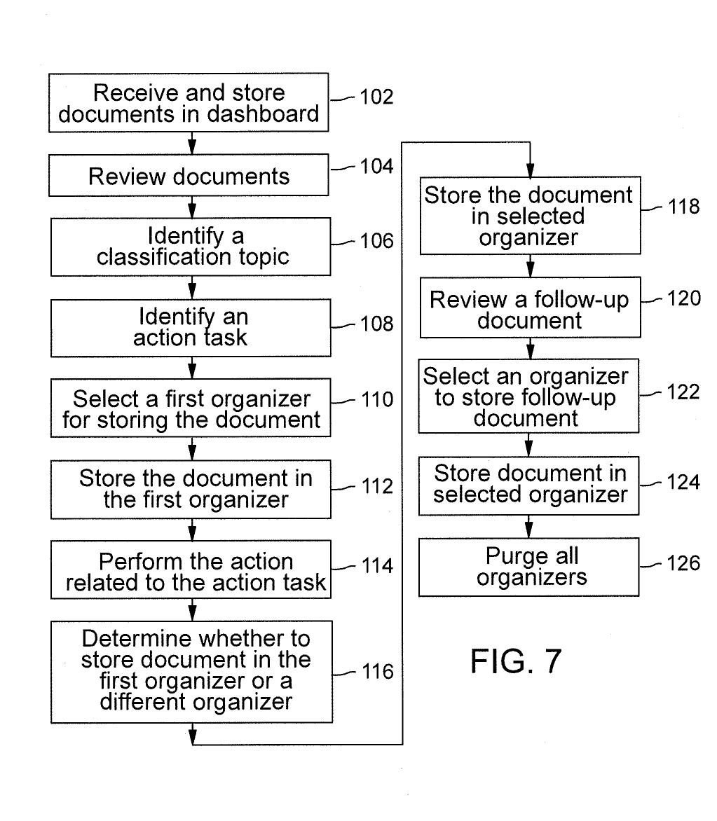

In general, the binders 24, 26 are used as reference books to aid the user when working on the documents 12 stored in the core and link files 18, 20. In addition, by storing reference materials and working documents in separate containers, the user is able to maintain relatively clean and manageable core and link files 18, 20 so that the user can focus on completing the action tasks for the documents 12. An example process of using the core and link files 18, 20 and the binders 24, 26 is described in further detail below with regard to FIGS. 6-7.

In some embodiments, the document management system 10 further includes one or more archive boxes 28 for storing long-term documents and materials. Preferably, the archive boxes 28 include a core archive box 30 for storing documents and materials relating to the core files 18 (or the core subjects). In some embodiments, the core archive box 30 may retain documents 12 relating to legal or financial documents, such as a will, medical directives, and completed tax returns. As is described below in further detail with respect to FIGS. 6-7, the core archive box 30 may ultimately include documents 12 that were handled by the user in an earlier phase of the organization process, such as when the document 12 was initially stored in the core files 18. Accordingly, the core archive box 30 is meant for long-term storage of documents 12 that may memorialize significant legal, financial, medical, or other similar events, but may no longer require further action by the user. Preferably, the core archive box 30 includes dividers or compartments with substantially similar or identical categories to track the core files 18 and core binders 24.

With reference to FIGS. 1-3, the archive boxes 28 further includes a memento box 32 for storing personal documents 12 or treasures, such as photos, yearbooks, birthday cards, or other mementos that may have personal significance to the user. Many of the documents 12 in the memento box 32 may be related to or produced from the documents 12 that were initially stored in the link files 20. In a home environment with multiple users of the document management system 10, each of the users may have an individual memento box 32 to allow the user to quickly locate his or her own personal documents and treasures. In some embodiments, the mementos box 32 may include dividers or compartments with substantially similar or identical categories to the link files 20 and link binders 26.

With reference to the files 16, binders 22, and archive boxes 28, it should be understood that the previous examples relating to possible organization topics and category labels are merely for illustration purposes. As mentioned previously, the document management system 10 is adaptable to the particular needs of individual users and households. Accordingly, the user may dictate any category labels as desired that may be the same or different than the specific examples described herein. In some embodiments, some or all of the files 16, the binders 22, and the archive boxes 28 may include blank dividers that may be labeled, relabeled, and combined as a user's needs develop and change over time. In such embodiments, the user may be able to tailor the document management system 10 as the user's needs transition based on changes in life stages (e.g., transitioning from teenager to adult, student to working adult, single life to family).

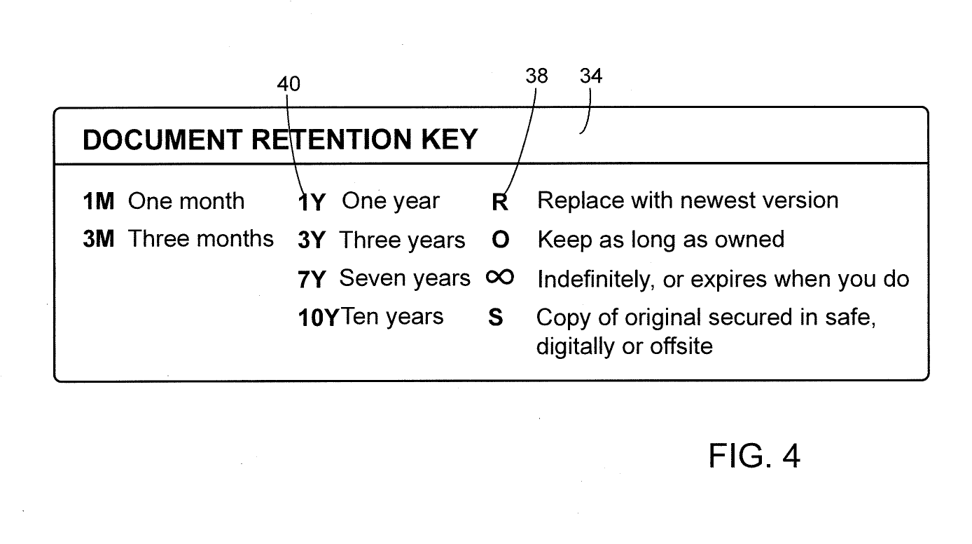

FIGS. 4-5 illustrate example embodiments of a document retention key 34 and a document retention legend 36, respectively, that together provide a cleaning mechanism for helping users retain only the documents 12 that they need. The document retention key 34 and document retention legend 36 may each be printed onto or otherwise displayed (e.g., as a standalone insert) in readable form in connection with one or more of the files 16, the binders 22, and the archive boxes 28. For example, the document retention key 34 and document retention legend 36 may be printed onto an interior surface of each of the core files 18 so that when a user opens a particular file, the user can easily view the retention information and understand the applicable retention actions for the documents 12. Preferably, the document retention legend 36 and document retention key 34 are printed on the same surface (e.g., an interior flap of the files 16 or the binders 22) as the information (e.g., guidance tips and prompts) that helps guide the user in determining which documents to store in particular dividers. In such an arrangement, the interior surface of the files 16 or binders 22 contains the primary reference information that the user needs.

With reference to FIGS. 4-5, the document retention key 34 and document retention legend 36 operate together to provide document retention guidelines that generally describe to the user what to do with a specific document 12 and provide a time frame for taking that action. With reference to FIG. 4, the document retention key 34 includes a plurality of retention codes 38 that each provide written instructions for managing the documents 12 stored in the various containers of the document management system 10, and also includes a retention period of time 40 indicating a time frame for taking the prescribed action.

In one embodiment, the retention code 38 may include four general categories for retaining the documents 12. For instance, a label “R” may be used to indicate that a particular document 12 should be replaced as soon as a newer or updated version of the document 12 (e.g., a mortgage statement) is received and stored in any of the containers (e.g., files 16, binders 22, or archive boxes 28) of the document management system 10. A label “O” may be used to indicate that the document 12 should be kept and stored as long as an item or service associated with the document 12 is owned or retained by the user (e.g., a phone contract). A label “∞” may be used to indicate that a particular document 12 should be retained indefinitely, or until the user passes away (e.g., a birth certificate). A label “S” may be used to indicate that the particular document 12 is a copy of an original document that is stored digitally, in a safe, or other offsite location (e.g., an executed will).

The retention period of time 40 indicates a period of time for retaining the document 12. FIG. 4 illustrates some examples for periods of time for retaining documents 12. Briefly, the label “1M” indicates that the document 12 should be retained for one month, and documents 12 labeled “3M” indicate that such documents 12 should be retained for three months, and so forth.

It should be understood that the example retention codes 38 and retention periods of time 40 illustrated in FIG. 4 are merely examples and may be different in other embodiments. In other embodiments, the retention codes 38 and retention periods of time 40 may be different, or include more or fewer entries than those specifically described herein.

Turning to FIG. 5, the following briefly describes an example process for using the document retention key 34 and document retention legend 36 to manage the documents 12 in the document management system 10. With particular reference to FIG. 4, the document retention legend 36 assigns a retention code 38 and/or a retention period of time 40 for each of the various categories 42 of documents 12 stored in a particular container. The retention code 38 and/or retention period of time 40 may differ between the various categories 42 of different containers.

For example, FIG. 5 illustrates an example document retention legend 36 for a provider file within the core files 18. The retention legend 36 describes various categories 42 of documents 12 that may be stored in the provider file. As illustrated, each of these categories 42 includes retention codes 38′ or retention periods 40′ (some categories 42 may include both retention codes 38′ and retention periods 40′ if desired). As described previously, the retention codes 38′ and retention periods 40′ help the user retain only the documents 12 that may be needed and only for a specific period of time that those documents 12 may be useful.

In an example operation, when evaluating a document 12, the user finds the category 42 pertaining to the particular document 12, and notes the retention instructions provided by the retention code 38′ and/or the retention period 40′. If necessary, the user may refer to the document retention key 34 to identify the retention instructions associated with the document 12. For example, according to the document retention legend 36, documents 12 relating to “Service or product overviews, offerings, and options” are marked with the retention code “R.” Consulting the retention key 34 in FIG. 4, the retention code “R” describes that these documents 12 relating to service or product overviews, offerings, and options should be retained until a new version of the document 12 is received, such as an updated service contract. When the updated service contract is received, the previous contract may be removed and thrown away, shredded, recycled, or otherwise discarded, and the updated contract replace it in the provider file.

For each of the files 16, binders 22, and archive boxes 28, the user may refer to the document retention legend 36 once a month (or at any other desired interval) to periodically purge the documents 12 from the various containers of the document management system 10. By continually following the retention guidelines, the user is able to thin out the documents 12 stored in the various containers and maintain a lean and manageable record of important documents.

FIGS. 6-7 collectively illustrate a process for using the document management system 10 according to one embodiment. FIG. 6 illustrates an example of how the connected structure containers (e.g., files 16, binders 22, and archive boxes 28) operate together throughout the life cycle of a tax return and FIG. 7 is a block diagram describing a method for managing and organizing documents using the document management system 10. The following section describes the general methods for organizing documents using the document management system 10 (with particular reference to FIG. 7) and illustrates the steps in the method to managing documents related to filing a tax return (with particular reference to FIG. 6).

With reference to FIGS. 6-7, at step 102, the user receives incoming documents 12 and stores them in the dashboard file 14 until the user is ready to process and organize the documents 12. Typically, as in the case of tax documents, the documents 12 may be received over an extended period of time, such as throughout the course of the year. At step 104, the user reviews the information contained in the incoming documents 12. In the illustrated example, the user reviews the documents 12 and identifies a donation letter, a home office receipt, a mortgage interest statement, and a W-2 form. At step 106, the user identifies a classification topic for each of the incoming documents 12, and at step 108 the user identifies an action task associated with each of the incoming documents 12, the action task specifying a subsequent action to be performed at a later date. In the illustrated example, the documents 12 are identified as tax documents to be used in the preparation of an income tax return.

Once the classification topic and action task have been identified, at step 110, the user selects a first organizer (e.g., core files 18) from a plurality of organizers (e.g., files 16, binders 22, or archive boxes 28) in which to store each of the incoming documents 12 based on the identified classification topic and action task, and at step 112, stores the documents 12 in the selected organizer. In the illustrated example, the documents 12 are stored in the core file 18 under the tax preparation section (or divider) since these documents 12 are to be used at a later date for preparing taxes.

At step 114, the user performs the subsequent action (i.e., prepares and files the tax return) specified by the action task identified at step 108. Following the preparation and filing of the tax return, at step 116, the user then determines whether to retain and store some or all of the documents 12 (e.g., the donation letter, home office receipt, mortgage statement, and W-2) in the first organizer (e.g., the tax divider in the core file 18) or determines whether to reclassify some or all of the documents 12 and store the reclassified documents in a second, different organizer (e.g., the financial core binder 24, the core archive box 24). In some embodiments, the second organizer may include a trash, recycling bin, or shredder 8 (see FIG. 1) so that the user can directly discard some or all of the incoming documents 12. Thereafter, at step 118, the user stores the documents 12 in the first organizer or the second organizer depending on the user's prior decision at step 116.

In some embodiments, upon completion of the subsequent action (at step 114), the user may receive or generate a second document (not shown) relating to the subsequent action. In the illustrated example, the second document may be a copy of a filing or acknowledgement receipt, a copy of the completed tax return, or another related document. In such embodiments, at step 120, the user reviews the second document and, at step 122, the user determines whether to store the document in the first organizer (e.g., the tax divider in the core file 18), the second organizer (e.g., the core binder 24), or a third organizer (e.g., the core archive box 26). Thereafter, at step 124, the user stores the document in the selected organizer.

In some embodiments, the method may further include additional steps for purging the document management system 10 periodically at step 126. As described previously with regard to FIGS. 4-5, purging the document management system 10 may include assigning retention instructions and a retention period of time to the document 12, periodically reviewing the documents 12 to determine whether to remove or retain the document, and removing or the documents upon expiration of the retention period. Additional details of these steps have been provided with reference to FIGS. 4-5, so they will not be further described to avoid repetition.

It should be understood that the method described with reference to FIGS. 6-7 relates to an example use relating to the life cycle of a tax return and may include specific steps that may not be necessary for other kinds of documents. For example, in some cases, the user may simply store the document directly in the core binder 24 as a reference material, or in the core archive box 26, thereby bypassing some or most of the steps described above.

Generally, as described and illustrated in FIGS. 6-7, the method for managing and organizing documents may be defined as incorporating three primary principles: sorting, working, and retaining that form the core of the document management system 10. Sorting includes the steps of initially sorting the documents 12 in the dashboard file 14 and thereafter sorting the documents 12 in the files 16, binders 22, and archive boxes 28. After sorting, the next principle involves working on the documents 12, which includes reviewing and handling the action tasks associated with the documents 12 stored in the core files 18 and link files 20. Typically, the documents 12 secured in the binders 22 are reference materials that require no further action from the user, but may be used to handle the documents 12 in the core and link files 18, 20. The last principle relates to retaining and purging the documents 12. As described, the documents 12 may be retained in the files 16, the binders 22, and the archive boxes 28 and managed using the retention guidelines to periodically cleanse unnecessary documents 12 from the document management system 10.

In another embodiment, the method for managing documents comprises the following steps: (1) reviewing information displayed in readable form on an incoming first document; (2) identifying a classification topic for the first document based on the information displayed on the first document; (3) identifying an action task associated with the first document based on the information, wherein the action task specifies a subsequent action to be performed based on the information on the first document; (4) selecting a first organizer of a plurality of organizers based on both (a) the identified classification topic and (b) the action task associated with the first document; (5) storing the first document in the first organizer; (6) performing the subsequent action specified by the identified action task; (7) following completion of the subsequent action, developing a subsequent storage plan by determining whether to retain the first document in the first organizer or reclassify the first document and store the first document in a second organizer different from the first organizer; and (8) storing the first document in the first organizer or the second organizer based on the determined subsequent storage plan.

While the description of the document management system 10 has focused on managing and/or organizing printed or otherwise physical documents 12, it should be understood that the same or similar organization process may be used to handle electronic documents. For example, in an electronic counterpart to the described organization system 10, such as using eDocs 23 (see FIG. 1) each of the organizers described above (e.g., the files 16, the binder 22, and the archive boxes 28) may be represented as top-level folders, and the individual dividers or categories (e.g., the provider files, the tax files, etc.) may be represented as subfolders within each of the top-level folders. In such an arrangement, electronic documents may be filed and managed between the folders and subfolders, and periodically purged in a similar process as described with particular reference to FIGS. 6-7.

For example, electronic documents may be received in a dashboard folder, such as an email inbox, a dropbox, or other folder. From there, the user may review the documents and determine which top-level folder to store the document in, depending on the classification topic of the document and whether any outstanding action is associated with the document. Thereafter, the user may drag the document, or an icon representing the document, into the identified top-level folder and into a specific subfolder. Once the action task has been completed, the document may be moved to another top-level folder (e.g., a core binder or core archive box) or deleted.

In other embodiments, the document management system 10 may combine physical and digital approaches to provide a fully-integrated system capable of managing and organizing physical documents as well as electronic/digital documents. For example, in some embodiments, a user may wish to scan a particular document and maintain a copy in both physical and electronic form, or a user may receive bank statements in printed form and credit card statements in electronic form. By maintaining parallel document management systems 10 in both the physical and electronic worlds, the user can seamlessly manage and track documents in both environments, and if necessary in the future, convert the entire organization system 10 into purely electronic form.

Other embodiments are possible. Although the description above contains much specificity, these details should not be construed as limiting the scope of the invention, but as merely providing illustrations of some embodiments of the invention. It should be understood that subject matter disclosed in one portion herein can be combined with the subject matter of one or more of other portions herein as long as such combinations are not mutually exclusive or inoperable.

The terms and descriptions used above are set forth by way of illustration only and are not meant as limitations. Those skilled in the art will recognize that many variations can be made to the details of the above-described embodiments without departing from the underlying principles of the invention.

1. A document management system comprising:
a first organizer displaying in readable form a first classification category on a surface of the first organizer;
one or more dividers associated with the first organizer, each one of the dividers displaying in readable form a subject associated with the corresponding divider, wherein each of the dividers is configured to segregate one or more documents organized by the subject; and
a document retention legend displayed in readable form on at least one of the dividers, the document retention legend including: (a) a retention code with instructions for managing at least one of the one or more documents of the at least one divider, and (b) a retention period with instructions indicating a period of time for retaining at least one of the one or more documents stored within the at least one divider.

2. The system of claim 1, wherein the first organizer is a binder having a set of retainers, and wherein each of the one or more dividers further includes a set of openings for engaging the retainers of the binder to secure the dividers.

3. The system of claim 1, wherein each of the one or more dividers further includes text displayed in readable form thereon, the text providing guidance for a general topic relating to the subject of the corresponding divider.

4. The system of claim 1, wherein the document retention legend further includes instructions for handling at least one of the one or more documents of the at least one divider.

5. The system of claim 4, wherein the document retention legend further includes a notation identifying a second location at which a copy is kept of at least one of the one or more documents of the at least one divider.

6. The system of claim 1, wherein the subcategory for at least one of the dividers relates to documents having an action task associated therewith, wherein the action task is a subsequent action to be performed based on information contained in the documents.

7. The system of claim 1, further comprising:
a second organizer displaying in readable form a second classification category on a surface of the second organizer, the second classification category different from the first classification category; and
one or more second dividers housed therein, each one of the second dividers displaying in readable form a subject associated with the corresponding divider, wherein each of the second dividers is configured to segregate one or more documents organized by the subject.

8. The system of claim 7, wherein the second organizer is a second binder having a set of retainers, and wherein each of the second dividers further includes a set of openings for engaging the retainers of the binder to secure the second dividers.

9. The system of claim 7, further comprising a dashboard file, the dashboard file configured to receive one or more documents from both the first classification category and the second classification category.

10. A method for managing documents, the method comprising:
reviewing information displayed in readable form on an incoming first document;
identifying a classification topic for the incoming document based on the information displayed on the first document;
identifying an action task associated with the incoming document based on the information, wherein the action task specifies a subsequent action to be performed based on the information on the first document;
selecting a first organizer of a plurality of organizers based on both of the identified classification topic and the action task associated with the first document;
storing the first document in the first organizer;
performing the subsequent action specified by the identified action task;
following completion of the subsequent action, developing a subsequent storage plan by determining whether to retain the first document in the first organizer or reclassify the first document and store the first document in a second organizer different from the first organizer; and
storing the first document in the first organizer or the second organizer based on the determined subsequent storage plan.

11. The method of claim 10, further comprising:
reviewing information displayed in readable form on a second document generated in response to performing the subsequent action associated with the first document;
determining whether to retain the second document in the first organizer, the second organizer, or a third organizer; and
storing the second document in one of the first, second, or third organizers.

12. The method of claim 11, wherein the second document is a receipt or a statement.

13. The method of claim 10, wherein the first organizer and second organizer are both contained within a single organizer.

14. The method of claim 10, further comprising assigning a retention period to the first document, wherein the retention period indicates a period of time for retaining the first document.

15. The method of claim 14, wherein upon expiration of the retention period, the first document is removed from the first or second organizer and discarded.

16. The method of claim 14, further comprising assigning retention instructions to the incoming document, wherein the retention instructions indicate an action to be taken on the first document upon expiration of the retention period.
